(19) United States
(12) Patent Application Publication
(10) Pub. No.: US 2010/0144373 A1
(43) Pub. Date: Jun. 10, 2010

(54) METHOD AND SYSTEM FOR BORDER CONTROL

(75) Inventors: Eithan Goldfarb, Ness Ziona (IL); Gideon Hazzani, Rishon Le Zion (IL)

Correspondence Address: Lawrence A. Aaronson, P.C.;Lawrence A. Aaronson, 12850 Highway 9, Suite #600 PMB 338, Alpharetta, GA, 30004, US

(73) Assignee: VERINT SYSTEMS LTD., Herzliya Pituach (IL)

(21) Appl. No.: 12/497,799

(22) Filed: Jul. 6, 2009

(30) Foreign Application Priority Data
Jul. 20, 2008 (IL) 192917

(51) Int. Cl. H04W 24/00

(52) U.S. Cl. 455/456.3

(57) ABSTRACT

A method for location tracking that includes identifying a subset of users of a mobile communication network who are located in a predefined area of interest using a first location subsystem of the mobile communication network. One or more of the identified users are assigned to a second location subsystem of the mobile communication network, which is different from and has a higher resolution than the first location subsystem, to measure their respective locations. In variations, the locations may be passed to an operator, the subset of the users may be identified by passively monitoring location information generated in the mobile communication network, the second location subsystem may be provided with information regarding the users, and profiles of the users may be determined.

### FIELD OF THE DISCLOSURE

The present disclosure relates generally to location tracking, and particularly to methods and systems for tracking user locations in mobile communication networks.

### BACKGROUND OF THE DISCLOSURE

Mobile communication networks deploy various techniques for measuring the geographical locations of communication terminals. Such techniques are used, for example, for providing Location Based Services (LBS) and emergency services in cellular networks. (In the description that follows, the term “locating users” is used, for the sake of brevity, to mean “locating the communication terminals used by the users.” Communication terminals whose locations are tracked are referred to as target terminals or targets.)

Some location tracking techniques, referred to as network-based techniques, are carried out by the base stations and other network-side components, without using special hardware or software at the mobile terminal side. For example, Cell Identification (CID) techniques, also sometimes referred to as Cell Global Identity (CGI) techniques, locate the user by identifying the cell via which the user currently communicates. Enhanced CID (E-CID, also referred to as E-CGI) techniques combine CID information with timing information, which is indicative of the distance between the user and the base station. In third generation (3G) Universal Mobile Telecommunication System (UMTS) networks, for example, the timing information may comprise Round-Trip Time (RTT) values. In Global System for Mobile communication (GSM) applications, timing information may comprise Time Advance (TA) values.

Another network-based location technique, called Uplink Time Difference of Arrival (U-TDOA), determines the user position by comparing and calculating the difference in time required for a user transmission to reach different base station sites. The arrival time measurements are made by Location Measurement Units (LMUs) installed at selected base station sites. Yet another technique, referred to as Angle of Arrival (AOA), determines the user position by establishing lines of bearing from base station sites to the user.

Other location tracking techniques are terminal-based, i.e., use special hardware or software in the mobile terminal. For example, some techniques use measurements performed by a Global Positioning System (GPS) receiver installed in the communication terminal. In Assisted GPS (A-GPS) techniques, the GPS measurements are assisted by an assistance server external to the mobile terminal. The assistance server is sometimes equipped with another GPS receiver, whose position is known a-priori. Another terminal-based technique is Enhanced Observed Time Difference (E-OTD), in which the terminal measures the time differences between signal arrivals from different base stations. A similar terminal-based technique is called Enhanced Forward Link Trilateration (EFLT).

### SUMMARY OF THE DISCLOSURE

An embodiment described herein provides a computer-implemented method for location tracking, the method including:

identifying a subset of users of a mobile communication network who are located in a predefined area of interest by monitoring communications between the users and the mobile communication network using a first location subsystem of the mobile communication network; and

assigning a second location subsystem of the mobile communication network, which is different from and has a higher resolution than the first location subsystem, to measure respective locations of one or more of the identified users.

In some embodiments, the method includes outputting at least the measured locations, so as to present the measured locations to an operator.

In an embodiment, the first location subsystem identifies the subset of the users by passively monitoring location information generated in the mobile communication network and extracting the locations from the monitored location information. In another embodiment, assigning the second location subsystem includes sending a request to the second location subsystem to measure the locations, so as to cause the second location subsystem to measure the locations responsively to the request. In yet another embodiment, identifying the subset further includes causing the first location subsystem to measure the locations of the users in the subset.

In a disclosed embodiment, the mobile communication network includes first and second separate mobile communication networks, the first mobile communication network includes the first location subsystem and the second mobile communication network includes the second location subsystem. In still another embodiment, measuring the locations includes providing the second location subsystem with information regarding the users who were identified by the first location subsystem.

In an embodiment, assigning the second location subsystem includes requesting the second location subsystem to measure the locations, receiving at least some of the measured locations from the second location subsystem, and outputting each of the received measured locations individually, irrespective of other received measured locations. In some embodiments, assigning the second location subsystem includes sending periodic requests to the second location subsystem to measure the locations.

In an embodiment, the second location subsystem includes multiple location subsystems, and assigning the second location subsystem includes assigning one of the multiple location subsystems to measure the locations and, in response to a failure in the one of the multiple location subsystems, assigning another of the multiple location subsystems to measure the locations.

In some embodiments, assigning the second location subsystem includes excluding at least one user from being assigned to the second location subsystem, and causing the second location subsystem to measure the locations of only the identified users that are not excluded. Excluding the at least one user may include accepting a list of excluded users. Additionally or alternatively, excluding the at least one user may include determining respective profiles of the users identified in the area of interest so as to automatically determine the excluded users.

There is additionally provided, in accordance with an embodiment described herein, apparatus for location tracking, including:

a network interface, which is operative to communicate with a mobile communication network that includes a first location subsystem and a second location subsystem, which is different from and has a higher resolution than the first location subsystem; and

a processor, which is coupled to identify a subset of users of the mobile communication network who are located in a predefined area of interest by monitoring communications between the users and the mobile communication network using the first location subsystem, and to assign the second location subsystem to measure respective locations of one or more of the identified users.

The present disclosure will be more fully understood from the following detailed description of the embodiments thereof, taken together with the drawings in which:

### BRIEF DESCRIPTION OF THE DRAWINGS

FIG. 1 is a schematic, pictorial illustration of a border control system, in accordance with an embodiment of the present disclosure;

FIG. 2 is a block diagram that schematically illustrates a border control system, in accordance with an embodiment of the present disclosure;

FIG. 3 is a block diagram that schematically illustrates a location mediation server, in accordance with an embodiment of the present disclosure;

FIG. 4 is a flow chart that schematically illustrates a method for border control, in accordance with an embodiment of the present disclosure; and

FIG. 5 is a block diagram that schematically illustrates a shared border control system, in accordance with an alternative embodiment of the present disclosure.

### DETAILED DESCRIPTION OF EMBODIMENTS

### Overview

Embodiments of the present disclosure provide methods and systems for tracking users of a mobile communication system in a given Area Of Interest (AOI), such as in the vicinity of a border. The mobile communication network comprises two or more location subsystems, which operate using different location tracking technologies. In some embodiments that are described hereinbelow, a Location Mediation Server (LMS) assigns the different location measurement subsystems to measure locations of user terminals. Initially, the LMS assigns a certain low-resolution location subsystem to measure the locations of the users who are located in a predefined Area Of Interest (AOI). At some point, the LMS may determine that one or more of the users identified in the AOI is to be tracked by a high-resolution location subsystem. The LMS automatically invokes the high-resolution location subsystem to measure the locations of these users.

In some embodiments, all of the users identified in the AOI are tracked using the high-resolution subsystem, except for a list (sometimes referred to as a “white list”) of users that are excluded from high-resolution tracking. For example, users whose presence in the AOI is known a-priori to be normal may be excluded from high-resolution tracking. A list of excluded users may be provided to the LMS. Alternatively, user exclusion may be performed based on user profiling. In alternative embodiments, the LMS is provided with a list of users that are to be regarded as priority targets and tracked with high resolution. (The terms “low resolution” and “high resolution” are used herein in a relative sense. These terms are not meant to define any absolute resolution levels, but to indicate that priority targets are located at a higher resolution than other users.)

The location subsystems may comprise passive and/or active subsystems. Passive location subsystems use passive location techniques, i.e., techniques that measure user locations by passively monitoring location information that is generated in the network, without being invoked by any sort of location request. Active location subsystems, on the other hand, use active location techniques, i.e., actively measure user locations when invoked by explicit location requests.

The methods and systems described herein track user locations in the AOI in a manner that matches their priority level, while conserving network resources. In some embodiments, the general user activity in the AOI is monitored using passive means at a certain basic resolution. Targets that emerge in the AOI and are not excluded from high-resolution tracking are automatically identified and tracked at high resolution.

Typically, tracking users with high resolution involves triggering the network to provide accurate location measurements. Such active involvement in the network utilizes network resources. The methods and systems described herein minimize unnecessary utilization of network resources by selectively confining the high-resolution tracking to specific users in a specific geographical area.

In some system configurations that are described further below, the LMS interacts with location measurement subsystems in multiple communication networks, which may be operated by different service providers.

### System Description

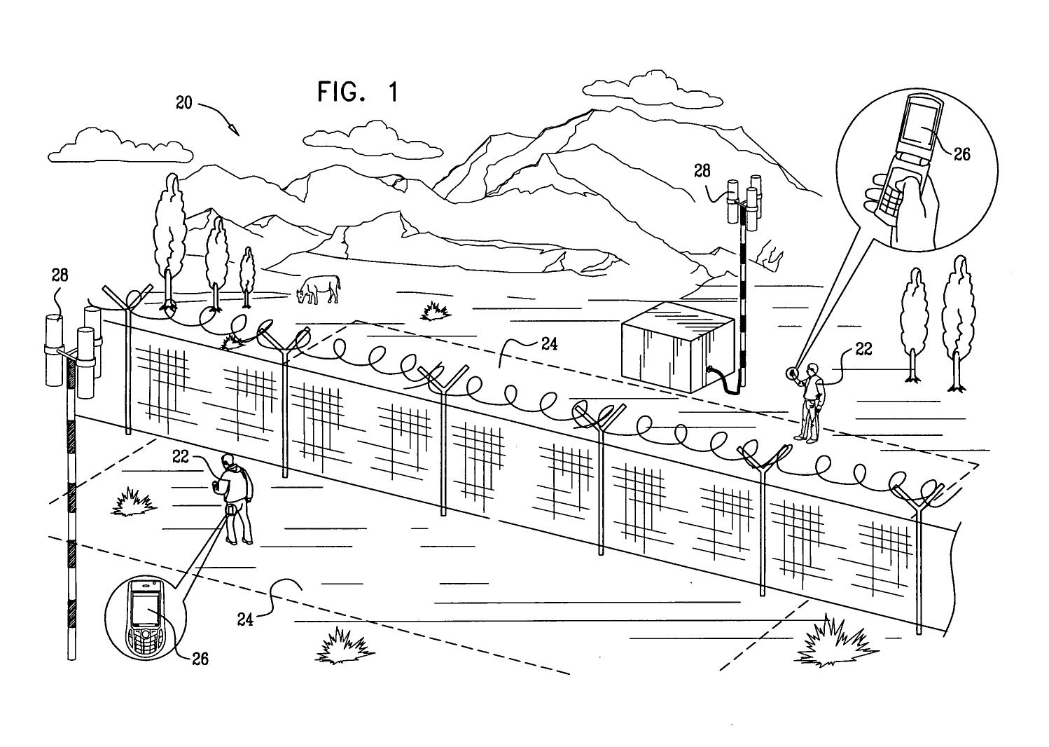

FIG. 1 is a schematic, pictorial illustration of a border control system 20, in accordance with an embodiment of the present disclosure. System 20 measures and tracks the locations of users 22 of a wireless communication network in a predefined Area Of Interest (AOI) 24. The users operate wireless terminals 26, such as mobile phones or mobile computing devices, which communicate with cellular base stations 28 of the mobile communication network. System 20 uses the resources of the mobile communication network, using methods that are described in detail below, to measure the locations of users 22 in the AOI.

In the embodiments described herein, system 20 comprises a surveillance system that is operated by a law enforcement agency or other government agency responsible for protecting the AOI. In the example of FIG. 1, AOI 24 is defined in the vicinity of a border. Alternatively, the AOI may comprise other sensitive areas such as airports or sensitive installations. Systems operating on the principles of the present disclosure may alternatively serve other applications. For example, a system may track and provide Location-Based Services (LBS) to users located in a predefined AOI, such as a shopping mall or a neighborhood.

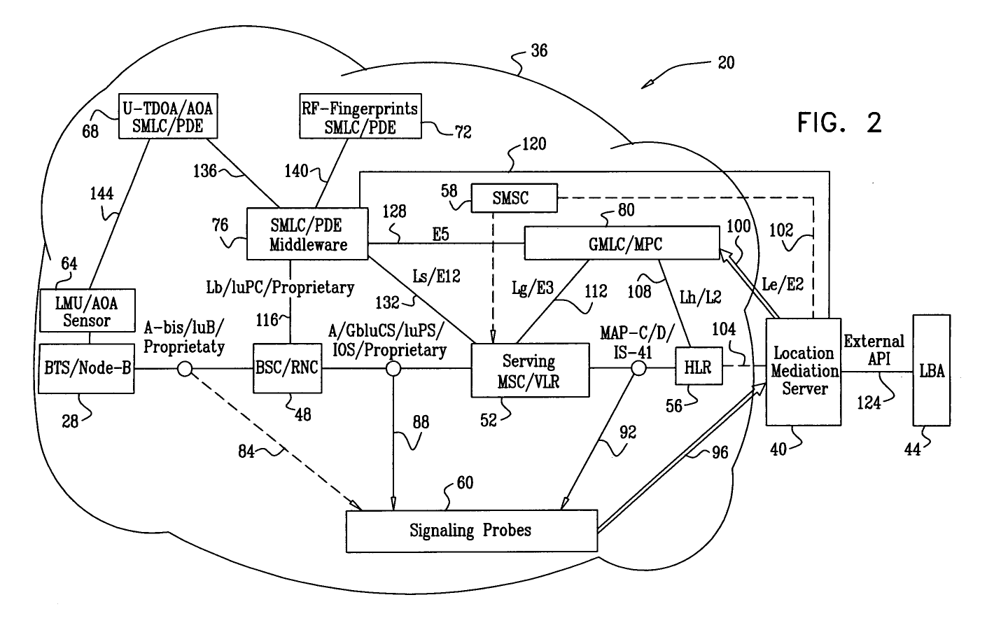

FIG. 2 is a block diagram that schematically illustrates border control system 20, in accordance with an embodiment of the present disclosure. System 20 comprises a mobile communication network 36, such as a cellular network, which is laid out in a geographical area that includes the AOI. Network 36 may comprise any suitable wireless communication network. The network may comprise, for example, a cellular network operating in accordance with any suitable cellular standard or protocol, such as a Universal Mobile Telecommunication System (UMTS) network, CDMA2000 network or other third generation (3G) cellular network, a Global System for Mobile communication (GSM) network or an Integrated Digital Enhanced Network (IDEN) network. Alternatively, network 36 may comprise a WiMAX network operating in accordance with the IEEE 802.16 standards or other wireless data network.

Network 36 comprises wireless base stations 28, also referred to as Base Transceiver Stations (BTS) or Node-B, which communicate with terminals 26. The base stations are connected to a core network, which comprises components such as Base Station Controllers (BSC, also referred to as Radio Network Controllers—RNC) 48, Mobile Switching Centers (MSC) 52 or other switches, subscriber databases such as a Home Location Register (HLR) 56, Short Message Service Centers (SMSC) 58, as well as various other components. In some cases, MSC 52 comprise Visitor Location Registers (VLR). Many types of network components and configurations are well-known in the art, and the methods and systems described herein can operate with any such network configuration.

Network 36 comprises multiple location measurement subsystems, which measure the geographical locations of terminals 26. Each location measurement subsystem operates in accordance with a certain location method, such as the CID, E-CID, A-GPS, U-TDOA, E-OTD and AOA methods described in the Background section above, or with any other suitable technique.

At least one of the location measurement subsystems in network 36 is passive. A passive location subsystem performs passive, unobtrusive probing of the signaling information transmitted in network 36, and extracts location information from the monitored signaling. Passive probing is performed without being triggered by any sort of location request. The extracted location information may comprise, for example, CID and E-CID information that is generated as a result of various events. For example, location information can be generated when terminals conduct voice calls, engage in Short Messaging Services (SMS) or other data sessions, perform registration (e.g., perform an “IMSI attach” procedure in GSM networks), perform handover or roaming, perform a Local Area Code (LAC) or Routing Area Code (RAC) update in a UMTS network, change operational states, perform periodic updates, or perform other actions.

Passive techniques are usually data-centric rather than target-centric. On one hand, such techniques do not consume additional resources of network 36. On the other hand, passive techniques can only provide the last known location of the tracked terminal, and cannot be actively invoked to produce up-to-date location information. When terminal activity is low, the accuracy and freshness of location information obtained by passive techniques may be limited. In the exemplary configuration of FIG. 2, network 36 comprises signaling probes 60, which tap the signaling traffic in the network. In the present context, probes 60 are regarded as passive location subsystems.

In some embodiments, network 36 comprises one or more active location measurement subsystems, such as subsystems that use E-CID and A-GPS techniques. Another active location measurement technique that may be used by network 36 is based on Radio Frequency (RF) fingerprints. An RF fingerprint comprises a set of attributes that characterize the manner in which a given mobile terminal is received by base stations 28, which is assumed to be indicative of the terminal's location. For example, the RF fingerprint of a given terminal may comprise a list of base stations that receive the terminals, and a corresponding list of signal levels at which the terminal is received. In the present example, different locations are typically characterized by different sets of base stations and signal strength levels (although the location indication may sometimes be ambiguous).

Active techniques are usually target-centric techniques that provide current information on a selected target terminal. Typically, active location is invoked by sending a location request (“LOCREQ”) to a Gateway Mobile Location Center (GMLC), as is known in the art. On one hand, active techniques can provide higher accuracy, more current location information in comparison with passive techniques. On the other hand, active techniques often consume network resources (e.g., capacity or processing power), which may be limited, and may be able to track only a limited number of targets simultaneously. In many cases, active techniques can be activated at different refresh rates, enabling a trade-off between accuracy and capacity.

In the example of FIG. 2, network 36 deploys two active subsystems. One active subsystem is based on U-TDOA and AOA and the other subsystem is based on RF fingerprints. The U-TDOA/AOA-based subsystem comprises a U-TDOA/AOA Serving Mobile Location Center (SMLC) or Position Determining Equipment (PDE) 68. SMLC 68 is connected by interfaces 144 to multiple Location Measurement Units (LMU) and/or AOA sensors 64, which are located at some or all of base stations 28. The fingerprint-based active subsystem comprises an RF fingerprint-based SMLC/PDE 72. SMLC/PDE 68 and 72 are operated by SMLC/PDE middleware 76, which in turn is controlled by a GMLC or Mobile Positioning Center (GMLC/MPC) 80. GMLC 80 is connected to the HLR by an interface 108 and to the MSC by an interface 112. Middleware 76 is typically used when the system comprises multiple active location subsystems, since many BSC/RNC configurations support only a single SMLC interface.

FIG. 2 indicates typical interfaces or protocols that may be used between the different units. These protocols are chosen purely by way of example, and any other suitable protocols or interfaces can also be used.

### Location Mediation Server

System 20 comprises a Location Mediation Server (LMS) 40, which interacts with the different passive and active location measurement subsystems. In some embodiments, LMS 40 issues location requests to the active subsystems, receives location information from both the active and the passive subsystems, and integrates the location information received from the different sources. In particular, LMS 40 assigns the appropriate measurement subsystems to measure the locations of the different terminals 26 located in AOI 24, as will be explained in detail below.

LMS 40 mediates between network 36 (and in particular the location subsystems) and one or more Location-Based Applications (LBA) 44. The LMS is connected to the LBA by an interface 124. The location-based applications may comprise a monitoring center, where an operator tracks the locations of mobile users 22. The operator may also perform additional functions using the monitoring center, such as defining certain mobile terminals as priority targets and/or modify the definition of AOI 24.

LMS 40 communicates with the passive and active location measurement subsystems in order to issue location requests and to obtain measured location information. When performing passive probing, for example, LMS 40 communicates with probes 60, which forward the passively-acquired location information to the LMS in real time over an interface 96. Probes 60 may obtain location information by monitoring interface 84 between the base stations and the BSC. Alternatively, the probes may monitor interfaces 88 between the BSC and MSC and/or interfaces 92 between the MSC and HLR. In some embodiments, the LMS may integrate the information received from the passive probes with information obtained from the active subsystems, such as by providing the passively-acquired information to SMLC middle 76 over an interface 120.

LMS 40 may invoke active location measurement in several ways. For example, LMS 40 may send GMLC 80 over an interface 100 a location request for locating a particular terminal 26. In response to the request, the GMLC invokes middleware 76 via an interface 128. Middleware 76 invokes SMLC 68 and/or 72 via interfaces 136 and/or 140, respectively. The SMLC/PDE middleware may communicate with the BSC via an interface 116, or with the MSC via an interface 132. Additionally or alternatively, the LMS may instruct SMSC 58, over an interface 102, to send a silent SMS message to a given terminal 26. In some embodiments, the silent SMS message is acknowledged by the target terminal, and the freshly-updated target location can be retrieved by the GMLC from HLR 56. The HLR can be interrogated, for example, using the MAP Lh interface or the Customized Application for Mobile network Enhanced Logic (CAMEL) protocol “Any Time Interrogation” command, over an interface 104.

The LMS, LBA and the application interface between them may support various operational modes and functions. For example, the LBA may send the LMS a list of targets (usually specified in terms of their Mobile Systems International Subscriber Identity Numbers—MSISDN). The LMS may issue location requests to the active location subsystem, requesting active locations of these targets. Typically, the location information obtained for the different targets is forwarded to the LBA as it arrives, irrespective of other targets. Thus, a delayed response from a given target does not delay the location tracking of other targets. In an alternative mode of operation, the LBA may send periodic queries to the LMS, indicating a list of targets to be located. Typically, the LMS returns the corresponding location information to the LBA in an asynchronous manner, i.e., as it becomes available individually for each target. In yet another operational mode, the LBA may request high-resolution tracking of all mobile terminals that are located within the AOI.

In some embodiments, the LMS provisions the active location subsystems (e.g., middleware 76, SMLC 68 and/or SMLC 72) with the targets that are to be located using active measurements. Upon a failure of a certain active location subsystem, the LMS may assign another subsystem to track the terminals that were previously tracked by the failed subsystems. For example, when a certain high-resolution subsystem fails, the LMS may revert to track targets using a lower-resolution technique, such as using a combination of CID and TA.

In some embodiments, the LMS may forward information collected by the passive location subsystem to the active subsystem. For example, when interfaces 84 and/or 88 are not available, the LMS may deliver RF parameters that were detected by the signaling probes (for some or all targets) to the SMLCs. When interfaces 84 and 88 are available, these RF parameters are typically provided to middleware 76 over interface 116 and distributed by the middleware to the different SMLCs. If the system comprises only a single SMLC (a single active location technique), the SMLC may be connected directly to the BSC, and middleware 76 may be omitted.

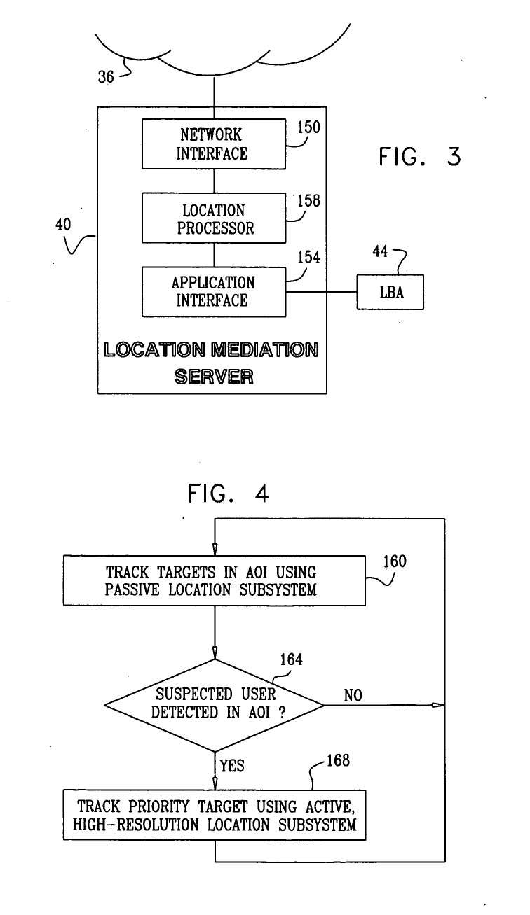

FIG. 3 is a block diagram that schematically illustrates LMS 40, in accordance with an embodiment of the present disclosure. The LMS comprises a network interface 150 for communicating with network 36 and an Application Interface (API) 154 for connecting to LBA 44.

The LMS further comprises a location processor 158, which carries out the methods described herein. Typically, processor 158 comprises a general-purpose computer, which is programmed in software to carry out the functions described herein. The software may be downloaded to the computer in electronic form, over a network, for example, or it may alternatively be supplied to the computer on tangible media, such as CD-ROM.

### Location Method Description

FIG. 4 is a flow chart that schematically illustrates a method for border control, in accordance with an embodiment of the present disclosure. The method identifies mobile terminals that are located in a given Area Of Interest (AOI), such as in the vicinity of a border, using passive probing. Some of the mobile terminals detected in the AOI are then assigned for higher-resolution tracking, typically by an active location subsystem. In some embodiments, the identities of the terminals that are to be tracked at high resolution (“suspected users”) are determined during operation, rather than a-priori.

In a typical implementation, all terminals detected in the AOI are tracked at high resolution, except for terminals that are explicitly excluded from high resolution tracking. Exclusion from high resolution tracking can be carried out in several ways. For example, system 20 may be provided with a “white list” of terminals that need not be tracked at high resolution, such as terminals that are known to belong to innocent residents of the AOI. Alternatively, the system may automatically profile the different users and determine which of the terminals are innocent and can be excluded from high-resolution tracking.

The method of FIG. 4 begins with system 20 tracking the locations of terminals 26 in AOI 24 using the passive location measurement subsystem, at a passive location step 160. In some embodiments, the LMS provides low-resolution location information (e.g., CID) of the tracked terminals to the LBA. In other embodiments, the LMS maintains the passively-collected location information internally.

The AOI may be defined, for example, as a list of cells of network 36. In these embodiments, a terminal that is communicating with a cell in the set is considered as being located in the AOI. Alternatively, the LMS may determine whether a given terminal is located inside or outside of the AOI using any other suitable method, based on the passively-collected location information.

In some embodiments, some of terminals 26 are predefined a-priori as being innocent and therefore excluded from high-resolution tracking. In some embodiments, a list of identifiers (e.g., MSISDNs) of the innocent users may be provided to the LMS by the LBA. Additionally or alternatively, the LBA may provide the LMS with a set of rules, which determine which terminals are to be excluded. Further additionally or alternatively, the identities of the excluded and/or suspected users may be specified to the LMS using any other suitable method. In some embodiments, the LBA may identify a target to the LMS in real time, such as when there is an immediate need to locate an idle terminal.

The LMS checks whether any of the passively-tracked terminals in the AOI comprises a suspected user (i.e., a terminal that has not been excluded from high-resolution tracking), at a target checking step 164. If no suspected user is identified in the AOI, the method loops back to step 160 above and the system continues to track terminals 26 using passive probing.

If, on the other hand, LMS 40 detects a suspected user in AOI 24, the LMS assigns a high-resolution location subsystem to track this user, at a high-resolution assignment step 168. The assigned location subsystem begins to measure the location of the suspected user and to provide high-resolution location information to the LMS. The LMS forwards the high-resolution location information to the LBA. High-resolution subsystems may comprise, for example, network-based subsystems such as U-TDOA, E-CID, AOA or RF fingerprint-based subsystems. Alternatively, the high-resolution subsystem may comprise a terminal-based subsystem such as A-GPS or E-OTD. Further alternatively, any other high-resolution location measurement technique can be used.

In some embodiments, the LMS provisions the different SMLCs in system 20 with a list of the terminals that are currently present in the AOI. This presence information may be based, for example, of CID information obtained from probes 60. The CID information may be obtained, for example, by monitoring interface 88. In some network configurations (e.g., in GSM and UMTS networks), interface 92 is also monitored in order to complete the mobile identity correlation.

The LMS may instruct the high-resolution subsystem to stop tracking a certain suspected user when the target is no longer in the AOI. The LMS may conclude that a terminal is not located in the AOI if it is detected in a different area, if no communication events are generated by the target for a certain period of time, and/or in response to an explicit command received from the LBA.

### Sharing Resources Between Wireless Operators

In some embodiments, the methods described herein can be carried out over two or more networks, which may be operated by the same network operator (service provider) or by different operators. In many practical cases, the AOI is covered by two or more mobile communication networks, each network comprising one or more location measurements subsystems. The different networks may use the same wireless standard or different standards. Thus, it is possible to share the location measurement resources of the different networks, so as to increase the overall performance and cost-effectiveness of the border control system.

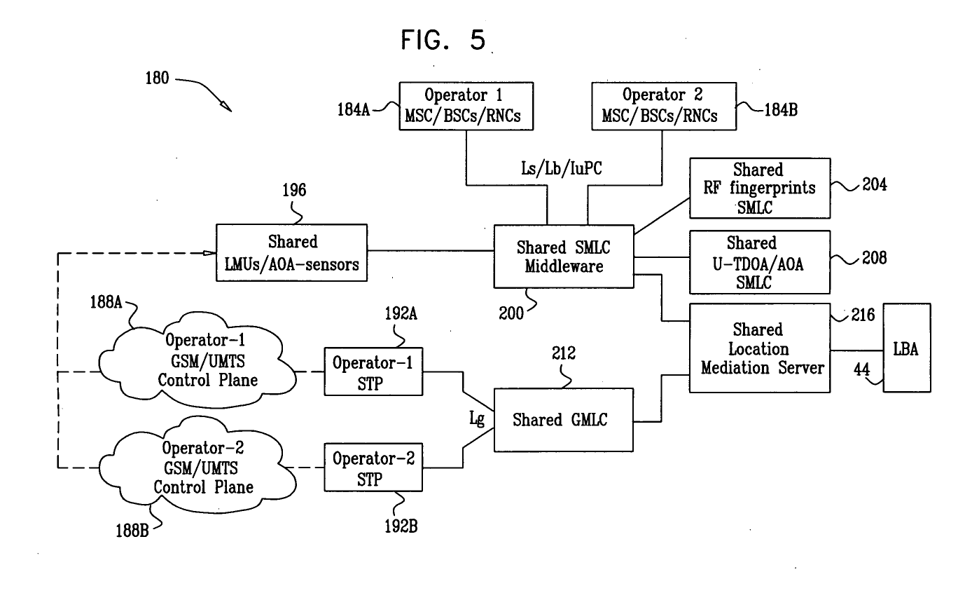

FIG. 5 is a block diagram that schematically illustrates a shared border control system 180, in accordance with an alternative embodiment of the present disclosure. In the present example, the border control system uses resources from two separate mobile communication networks, which belong to two different wireless operators.

The first network comprises a core network 184A, a control plane 188A and a Signaling Transfer Point (STP) 192A. The second network comprises a core network 184B, a control plane 188B and a STP 192B. The multiple STPs are connected to a shared GMLC 212. In some embodiments, LMUs/AOA sensors 196 are shared between the two networks. The system further comprises shared SMLC middleware 200, a shared RF fingerprints SMLC 204 and a shared U-TDOA/AOA SMLC 208.

System 180 comprises a shared LMS 216, which is connected to the shared GMLC and to the shared SMLC middleware. LMS 216 is similar in functionality to LMS 40 of FIGS. 2 and 3 above. The shared LMS also communicates with passive signaling probes (not shown in the figure), which are connected to one of the networks or to both. In some embodiments, the shared components may be located adjacently to the shared LMS. Although the description above refers to two networks, similar shared configurations can be defined for any number of networks.

Certain additional aspects of location tracking using multiple location measurement technologies are addressed in U.S. patent application Ser. No. 11/831,113, entitled “Dynamic Location Tracking of Mobile Communication Terminals,” filed Jul. 31, 2007, whose disclosure is incorporated herein by reference.

Although the embodiments described herein mainly address location tracking of users of communication terminals in mobile communication networks, the principles of the present disclosure can also be used for other applications, such as for implementing various location-based Value Added Services (VAS) and for tracking other types of communication terminals, such as vehicle and personal location transponders and paging devices.

It will thus be appreciated that the embodiments described above are cited by way of example, and that the present disclosure is not limited to what has been particularly shown and described hereinabove. Rather, the scope of the present disclosure includes both combinations and sub-combinations of the various features described hereinabove, as well as variations and modifications thereof which would occur to persons skilled in the art upon reading the foregoing description and which are not disclosed in the prior art.

1. A computer-implemented method for location tracking, the method comprising:
identifying a subset of users of a mobile communication network who are located in a predefined area of interest by monitoring communications between the users and the mobile communication network using a first location subsystem of the mobile communication network; and
assigning a second location subsystem of the mobile communication network, which is different from and has a higher resolution than the first location subsystem, to measure respective locations of one or more of the identified users.

2. The method according to claim 1, and comprising outputting at least the measured locations, so as to present the measured locations to an operator.

3. The method according to claim 1, wherein the first location subsystem identifies the subset of the users by passively monitoring location information generated in the mobile communication network and extracting the locations from the monitored location information.

4. The method according to claim 1, wherein assigning the second location subsystem comprises sending a request to the second location subsystem to measure the locations, so as to cause the second location subsystem to measure the locations responsively to the request.

5. (canceled)

6. The method according to claim 1, wherein the mobile communication network comprises first and second separate mobile communication networks, wherein the first mobile communication network comprises the first location subsystem and wherein the second mobile communication network comprises the second location subsystem.

7. The method according to claim 1, wherein assigning the second location subsystem comprises providing the second location subsystem with information regarding the users who were identified by the first location subsystem.

8. The method according to claim 1, wherein assigning the second location subsystem comprises requesting the second location subsystem to measure the locations of multiple identified users, receiving at least some of the measured locations from the second location subsystem, and outputting each of the received measured locations individually, irrespective of other received measured locations.

9. (canceled)

10. The method according to claim 1, wherein the second location subsystem comprises multiple location subsystems, and wherein assigning the second location subsystem comprises assigning one of the multiple location subsystems to measure the locations, in response to a failure in the one of the multiple location subsystems, assigning another of the multiple location subsystems to measure the locations.

11. The method according to claim 1, wherein assigning the second location subsystem comprises excluding at least one user from being assigned to the second location subsystem, and causing the second location subsystem to measure the locations of only the identified users that are not excluded.

12. (canceled)

13. The method according to claim 11, wherein excluding the at least one user comprises determining respective profiles of the users identified in the area of interest so as to automatically determine the excluded users.

14. Apparatus for location tracking, comprising:
a network interface, which is operative to communicate with a mobile communication network that includes a first location subsystem and a second location subsystem, which is different from and has a higher resolution than the first location subsystem; and
a processor, which is coupled to identify a subset of users of the mobile communication network who are located in a predefined area of interest by monitoring communications between the users and the mobile communication network using the first location subsystem, and to assign the second location subsystem to measure respective locations of one or more of the identified users.

15. The apparatus according to claim 14, and comprising an Application Interface (API), which is operative to output at least the measured locations so as to present the measured locations to an operator.

16. The apparatus according to claim 14, wherein the first location subsystem identifies the subset of the users by passively monitoring location information generated in the mobile communication network and extracting the locations from the monitored location information.

17. The apparatus according to claim 14, wherein the processor is coupled to send a request to the second location subsystem to measure the locations, so as to cause the second location subsystem to measure the locations responsively to the request.

18. (canceled)

19. The apparatus according to claim 14, wherein the mobile communication network comprises first and second separate mobile communication networks, wherein the first and second mobile communication networks respectively comprise the first and second location subsystems, and wherein the network interface is operative to communicate with both the first and the second mobile communication networks.

20. The apparatus according to claim 14, wherein the processor is coupled to provide the second location subsystem with information regarding the users who were identified by the first location subsystem.

21. The apparatus according to claim 14, wherein the processor is coupled to request the second location subsystem to measure the locations of multiple identified users, to receive at least some of the measured locations from the second location subsystem, and to output each of the received measured locations individually, irrespective of other received measured locations.

22. (canceled)

23. The apparatus according to claim 14, wherein the second location subsystem comprises multiple location subsystems, and wherein the processor is coupled to assign one of the multiple location subsystems to measure the locations and, in response to a failure in the one of the multiple location subsystems, to assign another of the multiple location subsystems to measure the locations.

24. The apparatus according to claim 14, wherein the processor is coupled to exclude at least one user from being assigned to the second location subsystem, and to cause the second location subsystem to measure the locations of only the identified users that are not excluded.

25. (canceled)

26. The apparatus according to claim 24, wherein the processor is coupled to determine respective profiles of the users identified in the area of interest so as to automatically determine the excluded users.
